(19) United States
(12) Patent Application Publication
(10) Pub. No.: US 2021/0369077 A1
(43) Pub. Date: Dec. 2, 2021

(54) SYSTEM FOR LOADING A DISHWASHER, GRIPPER SYSTEM FOR A LOADING ARRANGEMENT FOR LOADING A DISHWASHER, AND ALSO DISHWASHER

(71) Applicant: ILLINOIS TOOL WORKS INC., Glenview, IL (US)

(72) Inventors: Martin SCHREMPP, Biberach (DE); Marco PFEFFER, Hohberg (DE); Adrian BOLDT, Offenburg (DE)

(21) Appl. No.: 17/325,429

(22) Filed: May 20, 2021

(30) Foreign Application Priority Data
May 28, 2020 (DE) 10 2020 114 362.1

(51) Int. Cl. A47L 15/26; B25J 11/00; A47L 15/42

(52) U.S. Cl. CPC A47L 15/26; A47L 15/42; B25J 11/0085

(57) ABSTRACT

A system for loading a warewasher, which is embodied as a commercial conveyor warewasher. The loading system includes a gripping system having at least one parallel gripper (1), wherein the at least one parallel gripper (1) includes at least two clamping jaws (2, 3), between which a gripping region of the parallel gripper (1) is defined, wherein at least one of the at least two clamping jaws (2, 3) is segmented such that the at least one clamping jaw (2) is preferably automatically and/or self-adjustable at least in regions to a surface contour of a piece of washware to be gripped by the at least one parallel gripper (1).

### TECHNICAL FIELD

The present invention relates generally to the field of industrial washing. In particular, the invention relates to a system for loading a warewasher, which is embodied as a commercial conveyor warewasher, in particular. In addition, the present invention relates to a gripping system, in particular for a loading assembly for automatically loading a warewasher with washware and a conveyor warewasher with a corresponding loading system.

### BACKGROUND

Conveyor warewashers are used in the commercial sector. Unlike domestic dishwashers, in which the dishes to be cleaned remain stationary in the machine during cleaning, in conveyor warewashers the washware is conveyed through different treatment zones of the machine.

In the case of conveyor warewashers, the washware to be washed, such as trays, crockery, pots, glasses, cutlery, and other utensils to be cleaned, are conveyed through multiple treatment zones, such as pre-washing zone(s), main washing zone(s), after-washing or pre-rinsing zone(s), rinsing zone(s), and drying zone(s). A conveyor apparatus is used in order to convey washware in a conveying direction through the conveyor warewasher, said apparatus usually comprising at least compartments for receiving washware. In a belt conveyor warewasher, the compartments can be formed by support fingers on a conveyor belt of the conveyor apparatus. In rack conveyor warewashers, dish racks, in which compartments can be configured to receive the washware to be treated, serve as the conveyor apparatus. Here, it is conceivable for the dish racks to be conveyed through the rack conveyor warewasher by means of a conveying device.

The washware to be cleaned is typically presorted before being placed into the conveyor belt. A rack conveyor warewasher is known from publication U.S. Pat. No. 6,530,996 B2, for example, in which the washware to be treated is delivered to the respective treatment zones after being presorted in dish racks.

Conveyor warewashers are used in particular in large facilities such as dining halls and cafeterias in order to clean large quantities of soiled washware as economically as possible. With the conveyor warewashers of the currently known type, it is possible to clean several hundred place settings per hour. Studies have shown that, on average, each place setting typically consists of a tray, a plate, one or two bowls, a drinking glass, and a set of cutlery.

In almost all large kitchens, such as company cafeterias or dining halls, the washware used by the meal participants (dishes, drinking glasses, cutlery, etc.) is returned on trays. From the return station, the place settings are conveyed to the washing area. The place settings are typically conveyed by a corresponding feed conveyor belt. The place setting is conveyed by a conveyor belt from the return station into the washing area directly to a loading region of the conveyor warewasher.

In the loading/intake region of the conveyor warewasher, the washware pieces are then usually removed manually by service personnel and sorted into the conveyor belt of the conveyor warewasher.

With respect to trays or tray-like articles, presorting is usually carried out in such a way that the set of dishes and cutlery is removed manually from a tray to be cleaned by the service personnel, and the tray is then stacked in front of the conveyor apparatus or in the intake region (soiled side) of the conveyor warewasher. From time to time, the trays from this stack of trays are placed only with other trays into the conveyor belt of the conveyor warewasher and cleaned.

This homogenous approach has the advantage that trays cannot cast a spray shadow on smaller washware pieces stacked behind the trays. This approach also makes the work flow of stacking and unstacking much easier and more efficient than mixing the washware in with the trays to be cleaned.

However, while the trays from this stack of trays are placed only with other trays into the conveyor belt of the conveyor warewasher and cleaned, it is not possible to clean other washware, such as plates, bowls, or other dishes, because the trays to be placed into the conveyor belt must usually be placed into the conveyor belt transverse to the conveying direction and thus fill the entire available surface of the conveyor belt. Therefore, compared to other types of washware, a relatively large amount of time must be spent cleaning trays.

Furthermore, the service personnel of the conveyor warewasher must include each tray in their work flow at the machine inlet twice: the first time when removing the cutlery and dishes from the tray to be cleaned, and the second time when actually placing the trays into the conveyor belt of the conveyor warewasher.

In the described work process, the manual effort is particularly high. Each piece of washware (dish) of each place setting must be individually removed manually from the tray and placed into the conveyor belt of the warewasher.

Furthermore, the individual pieces of cutlery of each place setting must be removed manually from the tray and likewise delivered to the conveyor warewasher. This is followed by the previously described treatment of the actual trays.

With a machine capacity of several thousand plates per hour, it is in particular important to work as quickly and efficiently as possible, which increases the physical strain on the service personnel.

### SUMMARY

Based on the situation described above, the underlying problem of the present invention is to provide a solution for a conveyor warewasher of the type mentioned at the outset, in which it is possible to configure the entire washing and rinsing process more efficiently, as a result of which, in particular, the working time of the washing personnel can be decreased and the consumption of resources of the warewasher can be reduced

This problem is solved according to the invention by the subject matter of independent claim 1, wherein advantageous further developments of the loading system according to the invention are specified in the dependent claims.

Accordingly, the invention relates in particular to a system for preferably automatic or at least partially automatic loading of an industrial conveyor warewasher, in particular, wherein the loading system according to the invention comprises a feed conveyor belt for delivering washware to a loading area of the conveyor warewasher and a loading assembly for preferably automatic loading of the conveyor warewasher with washware.

According to the invention, it is particularly provided in this context that the loading assembly comprises a gripping system with at least one parallel gripper, wherein the at least one parallel gripper comprises at least two clamping jaws, between which a gripping region of the parallel gripper is defined.

Gripping systems comprising at least one parallel gripper are—at least in principle—generally known from gripping technology, for example as EOAT devices (EOAT=End-Of-Arm-Tools) and are often used in connection with industrial robots for handling objects/parts/workpieces. Typically, such EOAT devices comprise at least two pincer-like gripping jaws, which can be pivoted with respect to each other or can be moved linearly against each other along suitable guides and that capture and clamp an object or part/workpiece to be gripped with gripping surfaces facing each other from opposite sides.

Such EOAT devices thus fulfill the function of sensing and holding and establish the connection between a robotic arm and the workpiece/object/part. Decisive factors for a secure connection are the type of effect pairing and the number of contact levels. The effect pairing may be achieved via force, shape, or substance pairing. When a force pairing is employed, the hold is generated by applying pressure to the workpiece surface. By contrast, in the shape pairing, the hold takes place via an isomorphic envelopment of the workpiece.

Although gripping systems with parallel grippers may be generally known from the manufacturing industry during assembly, in particular, such gripping systems are not, or at least not readily, usable as part of a loading assembly for preferably automatic loading of a warewasher with washware. This is in particular because conventional gripping systems that are embodied as an EOAT apparatus are specially configured with respect to the shaping, position, and orientation of the gripware to be manipulated. For example, conventional gripping systems embodied as an EOAT apparatus typically serve during assembly to capture predetermined gripware of a particular size and shape at a particular, predetermined gripping position, in order to then deposit the gripware at another predetermined position. In this respect, the gripping system is configured in particular with respect to the gripware to be manipulated, in particular with respect to the size, shape, and material of the gripware.

Such a design of the gripping system, specialized in terms of the gripware, is not feasible in a loading assembly for the automatic loading of a conveyor warewasher with washware. The reason for this is that an automatically operating loading assembly of a conveyor warewasher must be configured so that it can handle a variety of different types of washware (different in terms of size, shape, weight, and material) in order to be able to realize an automatic loading of a conveyor warewasher.

In other words, for commercial washing it is not possible for an automatic loading of a conveyor warewasher with washware to use a gripping system that is optimized with respect to washware to be manipulated. Rather, the gripping system must be configured in order to handle a large variety of types of washware (such as small plates, large plates, bowls, small bowls, glasses, etc.).

This is precisely where the invention comes in, proposing that the loading assembly comprise a gripping system with at least one parallel gripper, wherein the at least one parallel gripper comprises at least two clamping jaws or gripping fingers, between which a gripping region of the parallel gripper is defined. In order to be able to handle different types of washware with the parallel gripper, in particular differently sized and/or shaped washware pieces, it is provided according to the invention that at least one of the at least two clamping jaws/gripping fingers of the parallel gripper is segmented such that the at least one clamping jaw/the at least one gripping finger is adjustable at least in regions to a surface contour of a washware piece to be gripped by the at least one parallel gripper.

Through this measure, it is possible that a large variety of types of washware can be manipulated with the parallel gripper. The loading system according to the invention is thus suitable for preferably automatic or at least semi-automatic loading of a commercial conveyor warewasher, in particular.

Because the parallel gripper comprises at least one clamping jaw/at least one gripping finger, which is at least partially adjustable to a surface contour of a washware part to be gripped by the parallel gripper, the parallel gripper can reliably fulfill the function of sensing and holding different washware pieces.

A secure connection between the parallel gripper and the washware to be manipulated is possible due to the feasible type of effect pairing and the number of contact levels that is feasible with the parallel gripper. The effect pairing is achieved in particular via a combination of a force and shape pairing.

In other words, the hold of the washware by the parallel gripper is generated by applying a pressure to the washware surface. At the same time, as a result of the shape pairing, the hold occurs via an isomorphic envelopment of the washware, in particular in regions.

Preferably, a parallel gripper that can be actuated with an electric motor drive is deliberately proposed as an effector for the gripping system of the loading assembly, although such electromotor-operated parallel grippers are rather unusual in the gripping and manipulating of gripware in gripping technology. Rather, pneumatically operated effectors, in particular in the form of so-called suction grippers, are primarily proposed in gripping technology for handling gripware for this purpose.

Such suction grippers are typically used in order to suck, lift, and move objects to another location. For this purpose, a suction gripper typically comprises at least one flexible suction cup, which delimits a suction space that is connectable to a vacuum source and comprises a front end region circumscribing a suction opening as well as an opposite rear end region. The suction opening of the suction cup is typically formed with a sealing lip that abuts or is attachable to the surface of the object to be handled and then encloses a suction space between the suction cup and the surface of the object, which can be evacuated accordingly. The suction cup therefore rests tightly against the surface of the object and pneumatically holds it in place.

However, when such a suction gripper is used in washing technology, it has been shown that suction grippers are not suitable for the handling of washware, because there is a risk, in particular when handling soiled washware, that food residues, etc., remaining on the washware to be handled, such as plates and bowls, clog the vacuum lines that are pneumatically connected to the suction space when evacuating the suction space, so that the washware can no longer be securely gripped.

Pneumatically actuated gripping pincers are also known from gripping technology.

However, even such pincers can only be used to a limited extent as an effector in the loading area of a conveyor warewasher, if at all, because the gripping pincers generally only have a limited gripping region, which makes it impossible to securely grip larger washware such as plates, cups, or bowls.

A further disadvantage of the pneumatically operated gripping pincers known from gripping technology can be seen in the fact that they require compressed air as the operating medium, which is usually not available in the washing areas.

In addition, pneumatically operated gripping pincers generally only allow two positions, namely the open position and closed position, which prevents pneumatically operated gripping pincers from being usable for a large variety of types of washware, in particular of different sizes and/or different shapes.

For this reason, according to the present invention, an electromotor-operated parallel gripper is preferably proposed as an effector for the automatic loading of the conveyor warewasher with washware. In such a parallel gripper, the associated clamping jaws/gripping fingers are at least partially adjustable over a gripping region of the parallel gripper with the aid of an electromotive drive.

A further advantage in the use of an electromotor-operated parallel gripper can be seen in that the effector, which is embodied as a parallel gripper, can be implemented in an easily realized manner with a self-inhibition mechanism, such that the latter retains the gripped washware in the stress-free state without transitioning into an open position.

Nevertheless, the invention is not limited to parallel grippers whose clamping jaws/gripping fingers are adjustable with the aid of an electromotive drive. Rather, the present invention is generally intended to relate to parallel grippers whose clamping jaws are—in whatever manner—automatically adjustable.

With the loading system according to the invention, the manual handling steps necessary for loading the conveyor warewasher can be significantly reduced, because, with the aid of the gripping system, not only plates but also bowls or glasses or other washware can be automatically sorted into the conveyor warewasher in an efficient manner.

In this way, manual work steps and thus the workload for the washing personnel can be reduced overall, because, ideally, the washing personnel no longer have to load the conveyor warewasher manually. The loading system according to the invention in particular ensures the most ergonomic and user-friendly operation of the conveyor warewasher possible, because a manual loading of the washware, in particular plates or cups/bowls, into the conveyor warewasher is no longer necessary.

In addition, with the loading system according to the invention, the cleaning result of the warewasher can be improved, because, with the aid of the loading assembly, all of the washware of a defined or definable group of washware can be automatically sorted on a correspondingly assigned conveyor belt or a correspondingly assigned conveyor track of a conveyor warewasher.

It is also possible to simplify the unloading process, because each washware group can be conveyed through the/a conveyor warewasher on a defined conveying track or a defined conveyor belt and thus arrives at the unloading region of the conveyor warewasher already presorted.

In order to be able to sort the washware delivered via the feed conveyor belt of the loading system according to the invention to the loading area of the conveyor warewasher according to predetermined or fixed groups of washware, it is conceivable that the loading system according to the invention comprises a washware detector apparatus, which serves to capture the type of washware delivered via the feed conveyor (plate, cups, bowl, etc.) and then, with the at least one parallel gripper, to dedicatedly lift a particular type of washware from the feed conveyor belt and sort it into a corresponding conveyor track of a conveyor warewasher.

The term “washware detector apparatus” as used herein is understood to be any detection apparatus that is designed to detect or determine the type of the washware delivered via the feed conveyor belt. In particular, it is conceivable here that the washware detector apparatus comprises at least one detector device, with which the size, the shape, and/or the material of the washware delivered via the feed conveyor belt can be determined.

According to conceivable implementations, the washware detector apparatus can comprise at least one preferably optically, inductively, or capacitively operating detector device, so that the size, the shape, and/or the material of the respective washware item can be determined for the purposes of identifying the type of washware. However, it is also possible to use other types of detectors, such as inductive proximity sensors, light scanners, light curtains, laser scanners, 3D lasers, cameras, rotary encoders, etc., as the detector device.

Due to the fact that the gripping system of the loading assembly comprises at least one parallel gripper, it is ensured that—with the exception of cutlery parts—almost all other types of washware can be manipulated accordingly, i.e. in particular removed from the feed conveyor belt and sorted into a preferably predetermined conveyor track of a conveyor warewasher.

In contrast to gripping pincers, the principle of action of parallel grippers is based on the fact that they comprise at least two clamping jaws/two gripping fingers, which are moveable relative to one another in a linear motion. In this context, for example, it is conceivable that at least one of the at least two clamping jaws/gripping fingers of the parallel gripper can be moved or driven by a type of “plunger.”

Alternatively, however, it is also conceivable to select a linear drive as the electromotive drive. Alternatively, a torque generated by an electromotive drive can also be transferred as needed via a gear arrangement to the at least one clamping jaw/the at least one gripping finger.

In order to optimize the reliability of the parallel gripper, it is provided in embodiments of the present invention that the gripping system or the at least one parallel gripper associated with the gripping system is provided with a sensor system, with which the correct relative position of a piece of washware to the gripping region of the parallel gripper and the presence of a piece of washware is detected or can be detected, a correct manipulation of the washware can be controlled by the parallel gripper, or corresponding processing parameters can be checked.

A significant contribution to the prior art can be seen in the fact that at least one of the at least two clamping jaws of the parallel gripper is segmented.

In other words, the at least one (segmented) clamping jaw consists of at least two sections (segments), which are movable relative to one another and are pivotable, in particular. Due to this segmentation, the (segmented) clamping jaw is variably adjustable to the surface contour of a washware part to be gripped by the at least one parallel gripper.

For particularly sensitive washware such as wine glasses, etc., a finer segmentation of the at least one clamping jaw is advantageous, so that this piece can be manipulated primarily via shape pairing with the aid of the parallel gripper. However, the invention is not limited to parallel grippers in which at least one clamping jaw is segmented into more than two sections.

Preferably, the at least two segments of the segmented clamping jaw are connected via an articulation region, in particular a rotational articulation region, such that the segments or at least one of the segments of the at least one segmented clamping jaw is movable and particularly pivotable as needed, in particular in the direction of the gripping region and/or in the opposite direction.

According to a preferred implementation of the solution according to the invention, it is provided that the at least one parallel gripper of the gripping system of the loading assembly comprises a gripper housing in which at least one drive is received or receivable at least in regions for at least one of the at least two clamping jaws of the parallel gripper. A carriage element, which can be moved relative to the gripper housing and can in particular be slid, is assigned to the drive.

In this embodiment, it is provided in particular that the at least one segmented clamping jaw of the parallel gripper with the carriage element, which is movable and in particular slidable relative to the gripper housing, is movable and in particular slidable relative to the housing.

Preferably, in addition to the at least one segmented clamping jaw, the parallel gripper comprises a clamping jaw, which is particularly configured as a gripping finger and is rigidly connected to the gripper housing.

In this context, the term “rigidly connected to the gripper housing” means that this clamping jaw, which is in particular configured as a gripping finger, is not moved, and in particular not slid, relative to the gripper housing when the carriage element is actuated.

According to alternative embodiments, each clamping jaw of the parallel gripper is assigned to a carriage element so that, as needed, each clamping jaw is movable and in particular slidable relative to the gripper housing and relative to the other clamping jaws.

In principle, it is advantageous that the at least two clamping jaws of the parallel gripper have a self-centering function. In order to realize this in a particularly simple but nevertheless effective manner, it is provided according to design variants of the loading system according to the invention that the parallel gripper comprises at least two and preferably exactly two clamping jaws, which are configured in particular as gripping fingers and are each rigidly connected to the gripper housing and are arranged side-by-side on a line that is perpendicular to the direction of movement of the carriage element.

This easy-to-realize implementation of the parallel gripper ensures that a piece of washware is captured by the clamping jaws of the parallel gripper via a three-point positioning. The fact that at least the segmented clamping jaw of the parallel gripper can be moved relative to the other clamping jaws configured as gripping fingers and relative to the washware to be gripped by the gripping system automatically makes a self-centering function feasible.

According to an alternative design variant, it is provided that the at least one parallel gripper comprises a gripper housing in which at least one drive is received or receivable for at least one of the at least two clamping jaws of the parallel gripper, wherein a carriage element that can be moved and in particular slid relative to the gripper housing is assigned to the drive. In this alternative design variant, the at least one segmented clamping jaw is rigidly connected to the gripper housing, while at least one further clamping jaw of the parallel gripper, which is preferably configured as a gripping finger, is movable and in particular slidable with the carriage element relative to the gripper housing.

In order to be able to realize a self-centering function of the parallel gripper in this variant, as well, it is provided according to further developments of the last described variant that the parallel gripper comprises at least two and preferably exactly two further clamping jaws, in particular being configured as gripping fingers, which are respectively movable and in particular slidable with the carriage element relative to the gripper housing, wherein the at least two and preferably exactly two further clamping jaws configured as gripping fingers are arranged side-by-side on a line that is perpendicular to the direction of movement of the carriage element.

Various solutions are considered for the implementation of the at least one segmented clamping jaw of the parallel gripper.

According to one design variant, the at least one segmented clamping jaw is embodied as an angle gripper, and in particular as a single finger angle gripper with a gripping finger, wherein the gripping finger of the angle gripper is pivotable into the gripping region of the parallel gripper as needed and can be pivotable out of the gripping region of the parallel gripper.

Of course, it is conceivable in this context that the gripping finger of the angle gripper comprises a plurality of segments/gripping fingers that can be pivoted relative to one another over a respective articulation region.

The last described design variants, in which the at least one segmented clamping jaw is embodied as an angle gripper and in particular as a single finger angle gripper with a gripping finger, are in principle a hybrid solution, namely a combination of a parallel gripper and an angle gripper. This hybrid solution significantly extends the scope of application of the parallel gripper, because the parallel gripper can reliably capture different types of washwares and in particular washwares having different surface contours.

The angular gripper preferably comprises a first segment/a first region which is either rigidly connected to the gripper housing of the parallel gripper or is movable relative to the gripper housing of the parallel gripper in the direction of the gripping region or in the opposite direction via the carriage element of the parallel gripper. On this first segment, a pivotally articulated gripping finger (second segment) is provided, which is operatively coupled to a drive assigned to the angle gripper, such that it is selectively, and preferably variably, pivotable between a first position, for example parallel to the gripping region of the parallel gripper, and a second position, in particular oblique or transverse to the first position, in the direction of the gripping region.

Nevertheless, in order to implement the at least one segmented clamping jaw of the parallel gripper, it is conceivable for the at least one segmented clamping jaw of the at least one parallel gripper to be configured such that, by fluid exposure and preferably compressed air exposure of at least one compressed air chamber, which is preferably formed at least in regions in the segmented clamping jaw, at least one segment of the segmented clamping jaw is movable and in particular pivotable, as needed, in the direction of the gripping region and/or in the opposite direction.

In order to optimize the functionality of the angle gripper, it is provided according to the design variants that a sensory system is provided on the gripping finger of the angle gripper, which captures the deflection of the gripping finger relative to the first segment of the angle gripper and/or captures a pressure applied with the gripping finger to a piece of washware.

Alternatively or in addition to an angle gripper as a segmented clamping jaw, it is conceivable for the at least one segmented clamping jaw to comprise a particularly elastic and preferably spring-elastic region, which is pretensioned in the direction of the gripping region and pushes against the pretensioning of the washware when gripping a piece of washware.

By providing such an elastic and in particular spring-elastic region, an optimal shape pairing can be achieved, namely in the case of washware of a large variety of types, wherein a maximum holding force acting on the washware is simultaneously adjustable or is limitable through the adjustment of the pretensioning force of the elastic region.

Advantageously, the pretensioned region of the segmented clamping jaw has, at least in regions, a convex shaping with respect to the gripping region of the parallel gripper.

According to embodiments of the loading system according to the invention, it is provided that the clamping jaws of the parallel gripper are at least partially coated with an elastic material.

The coating of the clamping jaws with an elastic material ensures that a piece of washware to be gripped, which is gripped between the at least two clamping jaws of the parallel gripper, is not damaged and/or that the clamping jaws are protected. This is particularly advantageous when washware is to be gripped that is particularly sensitive, such as glasses.

Advantageously, the clamping jaws of the parallel gripper are at least partially coated with an elastomer. Hydrogenated acrylonitrile butadiene rubber (HNBR) can also be considered as the elastic material.

HNBR material has the advantages that this material is very inert due to its lack of double bonds. Thus, the durability of the material is increased. In addition, HNBR material is relatively temperature-resistant, allowing the HNBR-coated clamping jaws to be operated up to a temperature of 150° C., for example, or to be brought into contact with washware having a temperature of up to 150° C.

In particular, it is conceivable that the elastic material may be vulcanized onto the clamping jaws in order to form a coating of elastic material, or that the jaws may be transformed with the elastic material by an injection molding process.

The term vulcanizing means, in particular, that an intermediate layer is provided between the elastic material and the material of the clamping jaw. The intermediate layer is a suitable binder in order to allow a firm connection of the elastic material to the material of the clamping jaw and in particular to prevent a porousness of the elastic material.

In case of a transforming of the clamping jaw with an elastic material, an injection molding process is preferably used, wherein the clamping jaw is inserted into a mold and the elastic material is cast into the mold in a fluid state, such that the elastic material fills a void between the injection mold and the clamping jaw. The elastic material then cures in the mold. Subsequently, the mold may be removed, and the clamping jaw formed by the elastic material may be retrieved.

In accordance with further developments of the last described aspect, it is provided that the clamping jaws of the parallel gripper each comprise at least one transverse bore. Due to the at least one transverse bore in the area of the jaws, it is achieved that the holding of the elastic material is improved when the jaws are coated with the elastic material. In particular, the holding of the elastic material on the clamping jaws is improved, namely in comparison to a case in which the clamping jaws are not further structured or modified, i.e. essentially smooth. In particular, it is provided that the elastic material covers the at least one transverse bore.

The invention is in no way limited to loading systems in which at least one parallel gripper with only two clamping jaws is used. Rather, the invention also relates to loading systems with parallel grippers, each having a total of three clamping jaws, which are movable relative to each other and relative to a piece of washware to be gripped by the gripping system, wherein a movement of the three clamping jaws is preferably synchronized.

Advantageously, the clamping jaws of the parallel gripper are configured in order to grip a washware piece to be gripped via frictional and/or positive locking.

Furthermore, according to preferred implementations of the loading system according to the invention, it is provided that an electromotive drive with a self-inhibition mechanism is assigned to the parallel gripper in order to actuate at least one of the at least two clamping jaws of the parallel gripper, wherein the self-inhibition mechanism is configured such that the electromotive drive fixes a relative distance of the clamping jaws to one another in a voltage-free state.

The invention further relates to a gripping system for a loading assembly for automatically loading a warewasher with washware, wherein the gripping system comprises a parallel gripper having at least two gripper jaws that can be moved and in particular slid relative to one another, wherein at least one of the gripping jaws is embodied as a single finger angle gripper

In this gripping system according to the invention, the further developments mentioned previously in connection with the loading system are also conceivable.

Furthermore, the invention relates to a conveyor warewasher having at least one conveyor apparatus, preferably in the form of at least one conveyor belt, wherein the conveyor warewasher is equipped with at least one loading system of the manner according to the invention described above at its inlet area for preferably automatic placement of the washware into the conveyor apparatus of the conveyor warewasher.

### BRIEF DESCRIPTION OF THE DRAWINGS

Exemplary embodiments of the solution according to the invention are described in more detail in the following with reference to the accompanying drawings.

The following are shown:

FIG. 1 schematically and in an isometric view, a first exemplary embodiment of a gripping system for a loading assembly for automatic loading of a warewasher, namely in a state in which the parallel gripper of the gripping system is moved to grip a plate placed on a tray from the side of the plate;

FIG. 2 schematically and in an isometric view, the gripping system according to FIG. 1, namely in a state in which the parallel gripper of the gripping system has gripped the plate;

FIG. 3 schematically and in a sectional view, the gripping system according to FIG. 2;

FIG. 4 schematically and in an isometric view, the first exemplary embodiment of the gripping system according to the invention, in a state in which a bowl set upon a tray is to be gripped by the parallel gripper of the gripping system and the parallel gripper is moved towards the bowl from above;

FIG. 5 schematically and in an isometric view, the gripping system according to FIG. 4, namely in a state in which the parallel gripper of the gripping system has gripped the bowl;

FIG. 6 schematically and in a side view, the gripping system according to FIG. 5;

FIG. 7 schematically and in an isometric view, a second exemplary embodiment of the gripping system according to the invention, namely in a state in which the parallel gripper of the gripping system is approached from the side by a plate placed on a tray;

FIG. 8 schematically and in a partially sectioned view, the gripping system according to FIG. 7, namely in a state in which the parallel gripper of the gripping system has gripped the plate;

FIG. 9 schematically and in an isometric view, the second exemplary embodiment of the gripping system according to the invention, namely in a state in which the parallel gripper of the gripping system is moved from above towards a bowl set upon a tray;

FIG. 10 schematically and in a partially sectioned view, the gripping system according to FIG. 9, namely in a state in which the parallel gripper of the gripping system has gripped the bowl;

FIG. 11 schematically and in an isometric view, a third exemplary embodiment of the gripping system according to the invention, namely in a state in which the parallel gripper of the gripping system is moved from above towards a bowl set upon a tray; and

FIG. 12 schematically and in an isometric view, the third exemplary embodiment of the gripping system according to the invention, namely in a state in which the parallel gripper of the gripping system is moved from the side towards a plate set upon a tray.

### DETAILED DESCRIPTION

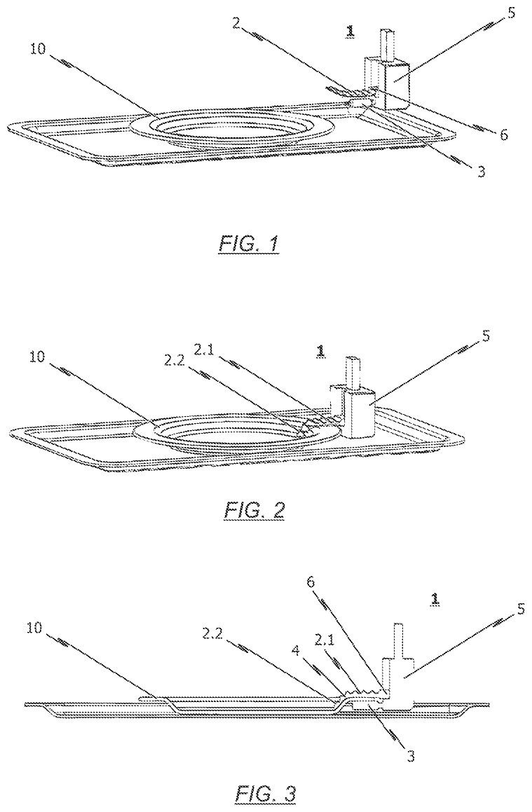

Referring now to the illustrations in FIG. 1 to FIG. 12, various embodiments of the parallel gripper 1 associated with the gripping system of the loading assembly will be described.

All embodiments have in common that the gripping system of the loading assembly comprises a parallel gripper 1, wherein at least one clamping jaw 2, 3 of the parallel gripper 1 is configured as a segmented clamping jaw 2, which allows this clamping jaw 2 to be at least partially adjustable to a surface contour of a washware piece 10, 11 to be gripped by the parallel gripper 1.

In detail, in the embodiments of the solution according to the invention as shown in the drawings, it is provided that the at least one segmented clamping jaw 2 of the parallel gripper 1 is divided into at least two and preferably more than two segments 2.1, 2.2, which can be moved and in particular pivoted relative to one another, wherein each segment 2.1, 2.2 is connected via an articulation region 4, in particular a rotational articulation region, to an adjacent segment 2.2, 2.1, such that the segments 2.1, 2.2 of the segmented clamping jaw 2 can be moved and in particular pivoted as needed in the direction of the gripping region and/or in the opposite direction

The embodiment of the parallel gripper 1 shown in FIG. 1 to FIG. 6 is characterized in that the parallel gripper 1 comprises a gripper housing 5, in which, at least in regions, a drive is received or receivable for at least one of the at least two clamping jaws 2, 3 of the parallel gripper 1.

Here, the drive is assigned to a carriage element 6 that can be moved and in particular slid relative to the gripper housing 5, wherein the segmented clamping jaw 2 with the carriage element 6 can be moved and in particular slid relative to the gripper housing 5.

The other (non-segmented) clamping jaw 3 of the parallel gripper 1 is configured as a gripping finger, which is rigidly connected to the gripper housing 5 of the parallel gripper 1.

On the one hand, by appropriately actuating the carriage element 6 of the parallel gripper 1, the feasible gripping region of the parallel gripper 1 can be varied. On the other hand, by configuring the clamping jaw, which can be movable with the carriage element 6, as a segmented clamping jaw 2, it is possible that in the gripped state, this clamping jaw 2 is automatically and/or self-adjustable, at least in regions, to a surface contour of a piece of washware 10, 11 gripped by the parallel gripper 1.

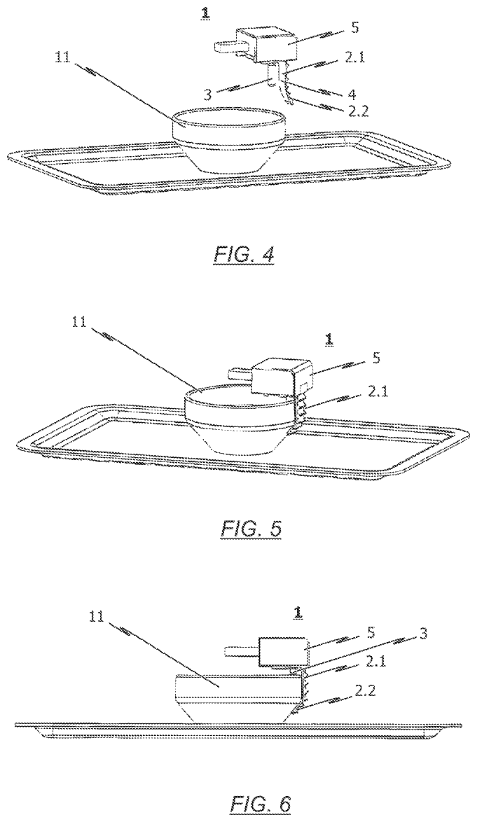

On the one hand, the parallel gripper 1 is suitable for manipulating flat dishes, for example plates 10 or saucers (cf. FIG. 1 through FIG. 3), while the rim of bowls 11, cups, or other pots may also be gripped due to a 90° rotation of the parallel gripper 1, as indicated in FIG. 4 through FIG. 6.

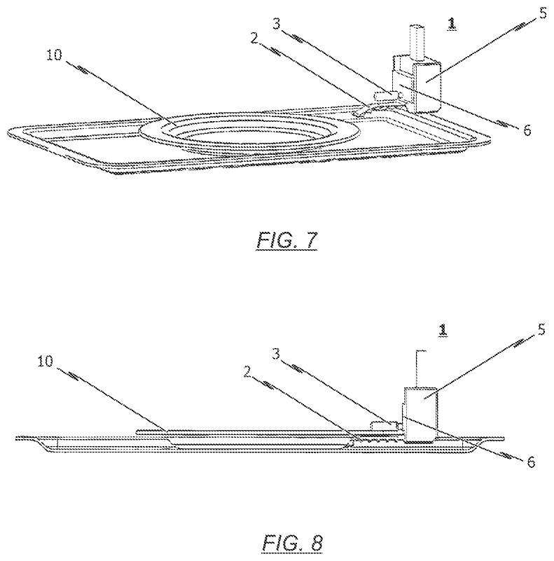

The second design variant shown in FIG. 7 to FIG. 10 is characterized in that the (non-segmented) gripping finger 3 of the parallel gripper 1 is movable and in particular slidable with the carriage element 6 relative to the gripper housing 5, whereas on the other hand the segmented clamping jaw 2 is rigidly connected to the gripper housing 5.

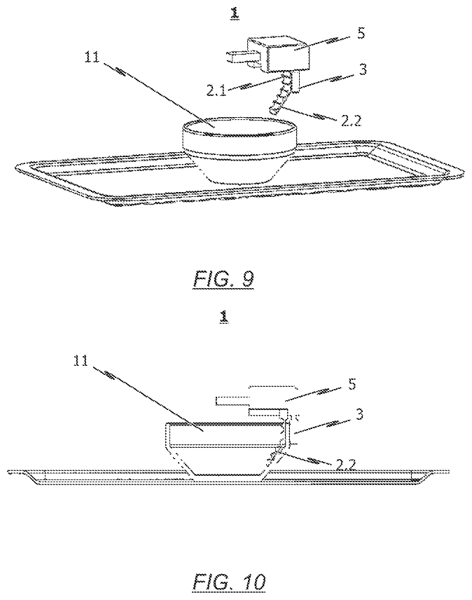

In this embodiment, a large variety of types of washware can also be safely manipulated. In detail, FIG. 7 and FIG. 8 show how flat washware, in particular plates 10, can be manipulated in the second embodiment, while FIG. 9 and FIG. 10 show that other types of washware, in particular bowls 11, cups, etc. can be manipulated with one and the same parallel gripper 1.

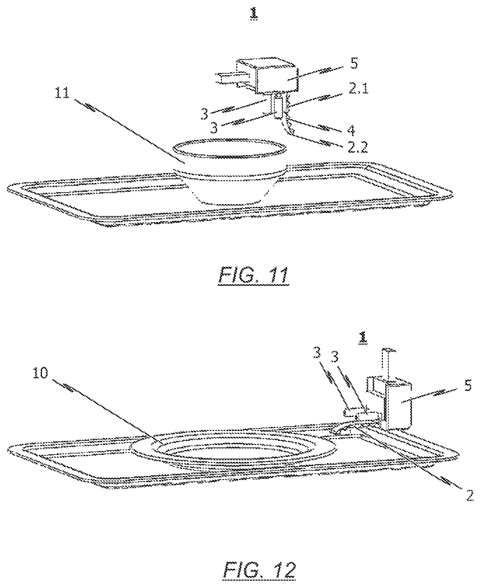

The further design variant shown in FIG. 11 and FIG. 12 is characterized in that a total of two non-segmented clamping jaws 3 are each provided in the form of a gripping finger, wherein these two gripping fingers are movable and in particular slidable with the carriage element 6 relative to the gripper housing 5. In particular, the two further clamping jaws 3 configured as gripping fingers are arranged side-by-side on a line extending perpendicular to the direction of movement of the carriage element 6

The invention is not limited to the design variants shown in the drawings, but results when all of the features disclosed herein are considered together.

In this context, it is also conceivable, in particular, that corresponding rigid or flexible/segmented clamping jaws 2, 3 are arranged on opposite sides of the gripper housing 5 in order to be able to realize different gripping regions in this way.

The invention further relates to a conveyor warewasher, not shown in the drawings, having at least one conveyor apparatus, preferably in the form of at least one conveyor belt, wherein the conveyor warewasher is equipped with at least one loading area at its inlet area for preferably automatic placement of the washware into the conveyor apparatus of the conveyor warewasher. The loading system comprises at least one parallel gripper 1 of the aforementioned type.

What is claimed is:

1. System for loading a warewasher, which is embodied as a commercial conveyor warewasher, wherein the system comprises a loading arrangement for automatic loading of the conveyor warewasher with washware, wherein the loading arrangement comprises a gripping system having at least one parallel gripper (1), wherein the at least one parallel gripper (1) comprises at least two clamping jaws (2, 3), between which a gripping region of the parallel gripper (1) is defined, wherein at least one of the at least two clamping jaws (2, 3) is segmented such that the at least one clamping jaw (2) is automatically and/or self-adjustable at least in regions to a surface contour of a piece of washware to be gripped by the at least one parallel gripper (1).

2. System according to claim 1,
wherein the at least one segmented clamping jaw (2) of the at least one parallel gripper (1) is divided into at least two segments (2.1, 2.2), which can be moved relative to one another, wherein each segment (2.1, 2.2) is connected via an articulation region (4) to an adjacent segment (2.2, 2.1), such that the segments (2.1, 2.2) of the at least segmented clamping jaw (2) can be moved as needed in the direction of the gripping region and/or in the opposite direction.

3. System according to claim 1,
wherein the at least one parallel gripper (1) comprises a gripper housing (5), in which, at least in regions, a drive for at least one of the at least two clamping jaws (2, 3) is received or receivable, wherein a carriage element (6), which can be moved relative to the gripper housing (5), is assigned to the drive, wherein the at least one segmented clamping jaw (2) is movable with the carriage element (6) relative to the gripper housing (4), and wherein the parallel gripper (1) comprises at least one clamping jaw (3), configured as a gripping finger, which is rigidly connected to the gripper housing (5).

4. System according to claim 3,
wherein the parallel gripper (1) comprises at least two clamping jaws (3), which are configured as gripping fingers and are each rigidly connected to the gripper housing (4) and which are arranged side-by-side on a line that is perpendicular to the direction of movement of the carriage element (6).

5. System according to claim 1,
wherein the at least one parallel gripper (1) comprises a gripper housing (5), in which, at least in regions, a drive for at least one of the at least two clamping jaws (2, 3) is received or receivable, wherein a carriage element (6), which can be moved relative to the gripper housing (5), is assigned to the drive, wherein the at least one segmented clamping jaw (2) is rigidly connected to the housing, and wherein at least one further clamping jaw (3) of the parallel gripper (1) is movable with the carriage element (6) relative to the gripper housing (5).

6. System according to claim 5,
wherein the parallel gripper (1) comprises at least two further clamping jaws (3), which are configured as gripping fingers, and which are respectively moveable with the carriage element (6) relative to the gripper housing (5), wherein the at least two further clamping jaws (3), which are configured as gripping fingers, are arranged side-by-side on a line that is perpendicular to the direction of movement of the carriage element (6).

7. System according to claim 1,
wherein the at least one segmented clamping jaw (2) is embodied as an angle gripper with a gripping finger, wherein the gripping finger of the angle gripper is pivotable, if necessary, into the gripping region of the parallel gripper (1) and is pivotable out of the gripping region of the parallel gripper (1).

8. System according to claim 7,
wherein the gripping finger of the angular gripper comprises a plurality of segments (2.1, 2.2) which can be pivoted relative to one another over a respective articulated region.

9. System according to claim 1,
wherein the at least one segmented clamping jaw (2) comprises a region, which is pretensioned in the direction of the gripping region of the parallel gripper (1) and pushes against the pretensioning of the washware (10, 11) when gripping a piece of washware, wherein the pretensioned region of the segmented clamping jaw (2) has, at least in regions, a convex shaping with respect to the gripping region of the parallel gripper (1).

10. System according to claim 1,
wherein the at least one segmented clamping jaw (2) of the at least one parallel gripper (1) is configured such that, by fluid exposure at least one segment of the segmented clamping jaw (2) is movable, as needed, in the direction of the gripping region and/or in the opposite direction.

11. System according to claim 1,
wherein the clamping jaws (2, 3) of the parallel gripper (1) are coated with an elastic material, at least in regions.

12. System according to claim 1,
wherein the clamping jaws (2, 3) of the parallel gripper (1) are configured in order to grip a piece of washware (10, 11) to be gripped via frictional and/or positive locking.

13. System according to claim 1,
wherein an electromotive drive is assigned to the parallel gripper (1) in order to manipulate at least one of the at least two clamping jaws (2, 3) as needed, wherein the electromotive drive is equipped with a self-inhibition mechanism such that the electromotive drive fixes a relative distance of the clamping jaws (2, 3) to one another in a voltage-free state.

14. Gripper system, for a loading arrangement for automatic loading of a warewasher with washware, wherein the gripper system comprises a parallel gripper (1) having at least two clamping jaws (2, 3) that can be moved relative to one another, wherein at least one of the clamping jaws (2, 3) is embodied as a single finger angle gripper.

15. A conveyor warewasher having at least one conveyor apparatus, wherein the conveyor warewasher is equipped at its inlet area with at least one system according to claim 1 for automatic placement of the washware into the conveyor apparatus of the conveyor warewasher.
